(19) United States
(12) Patent Application Publication
(10) Pub. No.: US 2025/0203336 A1
(43) Pub. Date: Jun. 19, 2025

(54) COMMUNICATION TERMINAL APPARATUS AND MANAGEMENT APPARATUS

(71) Applicant: JVCKENWOOD Corporation, Yokohama-shi (JP)

(72) Inventors: Hideaki Shimoda, Yokohama-shi (JP); Toshinobu Hiromori, Yokohama-shi (JP); Takuya Ozawa, Yokohama-shi (JP); Hiroaki Kumashiro, Yokohama-shi (JP); Ryoji Kirihara, Yokohama-shi (JP); Toshitaka Matsuoka, Yokohama-shi (JP); Akimi Iwasaki, Yokohama-shi (JP)

(21) Appl. No.: 19/068,027

(22) Filed: Mar. 3, 2025

Related U.S. Application Data
(63) Continuation of application No. PCT/JP2023/032110, filed on Sep. 1, 2023.

(30) Foreign Application Priority Data
Sep. 16, 2022 (JP) 2022-148583

(51) Int. Cl. H04W 4/90; H04W 4/029; H04W 4/33

(52) U.S. Cl. CPC H04W 4/90; H04W 4/029; H04W 4/33

(57) ABSTRACT

The communication terminal apparatus includes a first communication unit that performs communication by a first communication system, a second communication unit that performs communication by a second communication system, a storage unit that stores therein pieces of channel information on channels, a comparison unit that compares the pieces of channel information, and an operation unit that is able to select a piece of channel information displayed on a display unit. The second communication unit receives first channel information on a first channel that is used by a different communication terminal apparatus by the first communication system. The storage unit stores therein the first channel information that is received by the second communication unit. The comparison unit compares whether or not the first channel information that is stored and second channel information on a channel that is used by the subject communication terminal apparatus by the first communication unit coincide with each other. The display unit displays the first channel information when a comparison result obtained by the comparison unit does not indicate coincidence. The first communication unit performs change to the first channel and performs communication when the first channel that is displayed on the display unit is selected.

### CROSS-REFERENCE TO RELATED APPLICATIONS

This application is a Continuation of PCT International Application No. PCT/JP2023/032110 filed on Sep. 1, 2023 which claims the benefit of priority from Japanese Patent Application No. 2022-148583 filed on Sep. 16, 2022, the entire contents of both of which are incorporated herein by reference.

### BACKGROUND OF THE INVENTION

### 1. Field of the Invention

The present disclosure relates to a communication terminal apparatus and a management apparatus.

### 2. Description of the Related Art

Japanese Unexamined Patent Application Publication No. 2015-125733 describes a technology that, when a disaster occurs in a facility, automatically generates an evacuation group for each area based on location information on terminal apparatuses that are carried by evacuation target persons and allows the evacuation target persons to evacuate.

The technology described in Japanese Unexamined Patent Application Publication No. 2015-125733 does not take into account transfer of members between the groups after the groups are generated.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A communication terminal apparatus according to the present disclosure comprising:
a first communication unit that performs communication by a first communication system;
a second communication unit that performs communication by a second communication system as a near-field communication system that is different from the first communication system;
a storage unit that stores therein pieces of channel information on channels that perform communication by respective systems;
a comparison unit that compares the pieces of channel information that are stored in the storage unit;
a display unit that displays the pieces of channel information; and
an operation unit that is able to select a piece of channel information displayed on the display unit, wherein
the second communication unit receives first channel information on a first channel that is used by a closely-located different communication terminal apparatus by the first communication system,
the storage unit stores therein the first channel information that is received by the second communication unit,
the comparison unit compares whether or not the first channel information that is stored and second channel information on a channel that is used by the subject communication terminal apparatus by the first communication unit coincide with each other,
the display unit displays the first channel information when a comparison result obtained by the comparison unit does not indicate coincidence, and
the first communication unit performs change to the first channel and performs communication when the first channel that is displayed on the display unit is selected.

A management apparatus according to the present disclosure comprising:
a communication unit that performs communication with a communication terminal apparatus by a first communication system;
a storage unit that stores therein terminal information that is received by the communication unit, the terminal information being information in which information on a channel that is used by the communication terminal apparatus by the first communication system and an identifier of the communication terminal apparatus are associated with each other;
a counting unit that counts, for each of channels, number of the communication terminal apparatuses that use a same channel, based on the terminal information that is stored in the storage unit;
an upper limit value setting unit that sets, for each of the channels, an upper limit value of number of used apparatuses; and
a terminal selection unit that selects the communication terminal apparatus that is to be requested to change a used channel to a different channel, based on the number of the used apparatuses that is counted by the counting unit for each of the channels and based on the upper limit value that is set by the upper limit value setting unit for each of the channels, wherein
the terminal selection unit transmits information on a channel to be changed to the selected communication terminal apparatus by the communication unit.

### BRIEF DESCRIPTION OF THE DRAWINGS

FIG. 1 is a diagram illustrating a configuration example of a guide system according to a first embodiment;

FIG. 2 is a block diagram illustrating a configuration example of a management apparatus according to the first embodiment;

FIG. 3 is a block diagram illustrating a configuration example of a communication terminal apparatus according to the first embodiment;

FIG. 4 is a diagram for explaining a group generation process according to the first embodiment;

FIG. 5 is a sequence diagram illustrating the flow of the group generation process according to the first embodiment;

FIG. 6 is a diagram for explaining an overview of a process performed by communication terminal apparatuses according to a second embodiment;

FIG. 7 is a sequence diagram illustrating the flow of a group generation process according to the second embodiment;

FIG. 8 is a diagram for explaining a change of a channel according to the second embodiment;

FIG. 9 is a sequence diagram illustrating the flow of a process performed by a communication terminal apparatus according to a modification of the second embodiment; and

FIG. 10 is a sequence diagram illustrating the flow of a group generation process according to a third embodiment.

### DETAILED DESCRIPTION OF THE PREFERRED EMBODIMENTS

Embodiments according to the present disclosure will be described in detail below with reference to the accompanying drawings. Meanwhile, the present disclosure is not limited by the embodiments below. Further, in the embodiments below, the same components are denoted by the same reference symbols, and repeated explanation will be omitted.

### First Embodiment

### Guide System

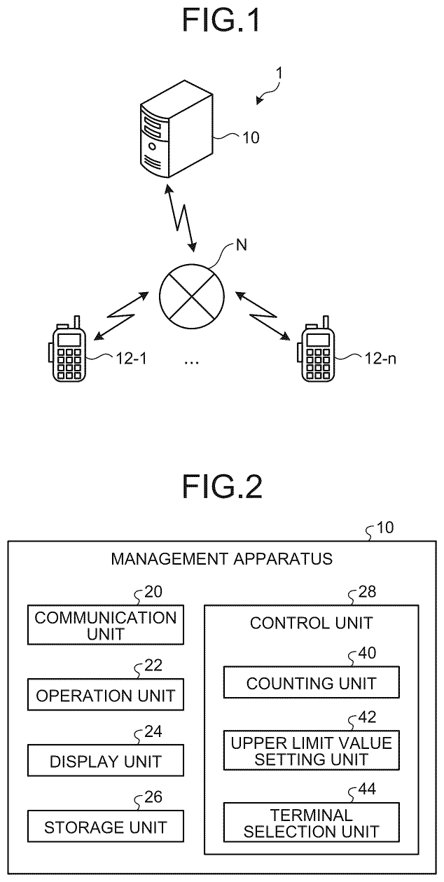

A configuration example of a guide system according to a first embodiment will be described below with reference to FIG. 1. FIG. 1 is a diagram illustrating a configuration example of the guide system according to the first embodiment.

As illustrated in FIG. 1, a guide system 1 includes a management apparatus 10 and a communication terminal apparatus 12-1 to a communication terminal apparatus 12-n (n is an integer equal to or larger than 2). Specifically, the guide system 1 includes the management apparatus 10 and a plurality of communication terminal apparatuses 12. The management apparatus 10 and the plurality of communication terminal apparatuses 12 are communicably connected to one another via a network N.

In the first embodiment, the guide system 1 is applied to, for example, a venue, such as a stadium, in which a sports competition, a concert, or the like is held. The guide system 1 is a system that is able to generate groups of users of the plurality of communication terminal apparatuses 12 and transfer the users between the groups.

### Management Apparatus

A configuration example of the management apparatus according to the first embodiment will be described below with reference to FIG. 2. FIG. 2 is a block diagram illustrating a configuration example of the management apparatus according to the first embodiment.

As illustrated in FIG. 2, the management apparatus 10 includes a communication unit 20, an operation unit 22, a display unit 24, a storage unit 26, and a control unit 28. The management apparatus 10 is implemented by, for example, an information processing apparatus, such as a Personal Computer (PC), that includes a communication unit.

The communication unit 20 transmits and receives various kinds of information to and from an external apparatus in a wired or wireless manner. For example, the communication unit 20 transmits and receives various kinds of information to and from the communication terminal apparatuses 12 via the network N. The communication unit 20 is implemented by, for example, a communication module that performs communication with a system using a wired Local Area Network (LAN), a wireless LAN, or the like. The communication unit 20 is implemented by, for example, a communication module that performs communication with a commercial wireless system.

The operation unit 22 receives various kinds of input operation on the management apparatus 10. The operation unit 22 outputs an input signal that corresponds to the received input operation to the control unit 28. The operation unit 22 includes, for example, a keyboard, a mouse, a touch panel, a button, a switch, or the like.

The display unit 24 displays various kinds of videos. The display unit 24 is, for example, a display including a Liquid Crystal Display (LCD), an organic Electro-Luminescence (EL), or the like.

The storage unit 26 stores therein various kinds of information. The storage unit 26 stores therein certain information, such as a calculation content of the control unit 28 and a program. The storage unit 26 includes, for example, at least one of a main storage device, such as a Random Access Memory (RAM) or a Read Only Memory (ROM), and an external storage device, such as a Hard Disk Drive (HDD).

The storage unit 26 stores therein, for example, terminal information on the communication terminal apparatus 12. The terminal information includes channel information on a changed channel of the communication terminal apparatus 12 that has changed a channel that is used by a first communication system, and identification information for identifying the communication terminal apparatus 12.

The control unit 28 controls each of the units of the management apparatus 10. The control unit 28 includes, for example, an information processing device, such as a Central Processing Unit (CPU) or a Micro Processing Unit (MPU), and a storage device, such as a RAM or a ROM. The control unit 28 may be implemented by, for example, an integrated circuit, such as an Application Specific Integrated Circuit (ASIC) or a Field Programmable Gate Array (FPGA). The control unit 28 may be implemented by a combination of hardware and software.

The control unit 28 includes a counting unit 40, an upper limit value setting unit 42, and a terminal selection unit 44.

The counting unit 40 counts, for each of channels, the number of the communication terminal apparatuses 12 that use the same channel. The counting unit 40 sets, for each of the channels, the number of the communication terminal apparatuses 12 that use the same channel based on the terminal information that is stored in the storage unit 26, for example.

The upper limit value setting unit 42 sets, for each of the channels, an upper limit value of the number of the used communication terminal apparatuses 12. For example, the upper limit value setting unit 42 may set an upper limit value that is determined in advance for each of the channels, or an administrator may set the upper limit value of the number of used apparatuses, where the upper limit value is input to the operation unit 22.

The terminal selection unit 44 selects the communication terminal apparatus 12 that is to be requested to change a channel. For example, the terminal selection unit 44 selects the communication terminal apparatus 12 that is to be requested to change a currently-used channel to a different channel, based on the number of the used communication terminal apparatuses 12, which is counted by the counting unit 40 for each of the channels, and based on the upper limit value of the number of the used communication terminal apparatuses 12, which is set by the upper limit value setting unit 42 for each of the channels. The upper limit value is a threshold for a request for the communication terminal apparatus 12 to change a channel. Communication terminal apparatus

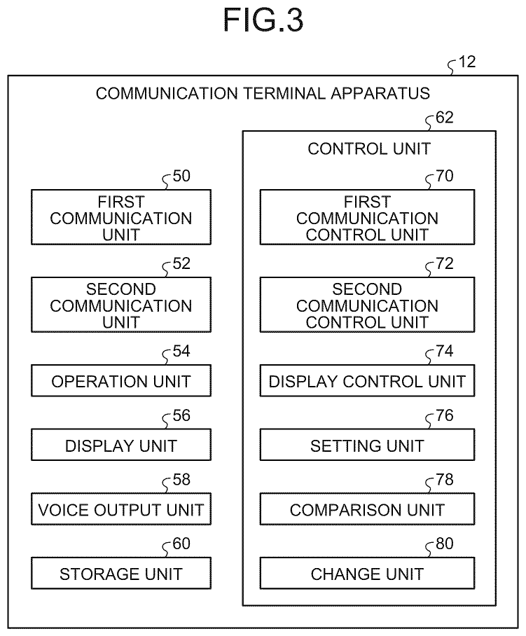

A configuration example of the communication terminal apparatus according to the first embodiment will be described below with reference to FIG. 3. FIG. 3 is a block diagram illustrating a configuration example of the communication terminal apparatus according to the first embodiment.

As illustrated in FIG. 3, the communication terminal apparatus 12 includes a first communication unit 50, a second communication unit 52, an operation unit 54, a display unit 56, a voice output unit 58, a storage unit 60, and a control unit 62. The communication terminal apparatus 12 is implemented by, for example, a portable communication apparatus, such as a commercial wireless communication apparatus or a smartphone.

The first communication unit 50 performs communication with the management apparatus 10 and the different communication terminal apparatus 12 via the network N. A communication system used by the first communication unit 50 is referred to as the first communication system. Examples of the first communication system include digital commercial radio, such as Association of Public safety Communications Officials international Project 25 (APCO-P25) and NXDN (registered trademark). The first communication system may be communication using the Internet network, a mobile phone network, or the like.

The second communication unit 52 performs communication with the different communication terminal apparatus 12 by a near-field wireless communication system. A communication system that is used by the second communication unit 52 is referred to as a second communication system. Examples of the near-field wireless communication system include Wi-Fi (registered trademark) and Bluetooth (registered trademark), but are not specifically limited. The second communication unit 52 receives, from the different communication terminal apparatus 12, first channel information on a channel that is used by the different communication terminal apparatus 12 by the first communication system, for example.

The operation unit 54 receives various kinds of input operation on the communication terminal apparatus 12. The operation unit 54 outputs an input signal corresponding to the received input operation to the control unit 62. The operation unit 54 includes, for example, a touch panel, a button, a switch, a microphone, a Push to Talk (PTT) button, or the like.

The display unit 56 displays various kinds of videos. The display unit 56 displays, for example, channel information on a channel for communication by the first communication system. The display unit 56 is, for example, a display including a liquid crystal display, an organic EL, or the like.

The voice output unit 58 outputs various kinds of voice. For example, the voice output unit 58 outputs voice of a user of the different communication terminal apparatus 12. For example, the voice output unit 58 outputs an alarm. The voice output unit 58 is a speaker.

The storage unit 60 stores therein various kinds of information. The storage unit 60 stores therein certain information, such as a calculation content of the control unit 62 and a program. The storage unit 60 includes, for example, at least one of a main storage device, such as a RAM or a ROM, and an external storage device, such as an HDD.

The control unit 62 controls each of the units of the communication terminal apparatus 12. The control unit 62 includes, for example, an information processing device, such as a CPU or an MPU, and a storage device, such as a RAM or a ROM. The control unit 62 may be implemented by, for example, an integrated circuit, such as an ASIC or an FPGA. The control unit 62 may be implemented by a combination of hardware and software.

The control unit 62 includes a first communication control unit 70, a second communication control unit 72, a display control unit 74, a setting unit 76, a comparison unit 78, and a change unit 80.

The first communication control unit 70 controls the first communication unit 50 and controls communication by the first communication system. The first communication control unit 70 causes the first communication unit 50 to set a predetermined channel and perform communication with the management apparatus 10 or the different communication terminal apparatus 12 by the first communication system.

The second communication control unit 72 controls the second communication unit 52 and controls communication by the second communication system. The second communication control unit 72 causes the second communication unit 52 to perform communication with the different communication terminal apparatus 12 by the second communication system. For example, the second communication control unit 72 receives channel information, which is received by the second communication unit 52 and which is about a channel that is used by the different communication terminal apparatus 12 with the first communication unit 50, and stores the received channel information in the storage unit 60. The channel information on the channel that is used by the different communication terminal apparatus 12 with the first communication unit 50 is also referred to as the first channel information.

The display control unit 74 causes the display unit 56 to display various kinds of videos. The display control unit 74 causes the display unit 56 to display channel information on a channel for communication by the first communication system.

The setting unit 76 sets a channel that is used by the first communication unit 50 by the first communication system. For example, the setting unit 76 sets the channel that is used by the first communication unit 50 by the first communication system based on information that is input to the operation unit 54.

The comparison unit 78 compares the first channel information that is stored in the storage unit 60 and second channel information on a channel that is used by the subject communication terminal apparatus 12 with the first communication unit 50. When the comparison unit 78 determines that the first channel information and the second channel information are different from each other, the display control unit 74 causes the display unit 56 to display the first channel information.

The change unit 80, when the operation unit 54 receives operation of changing to a first channel that is indicated by the first channel information displayed on the display unit 56, changes the channel that is set in the first communication unit 50 to the selected first channel.

### Group Generation Process

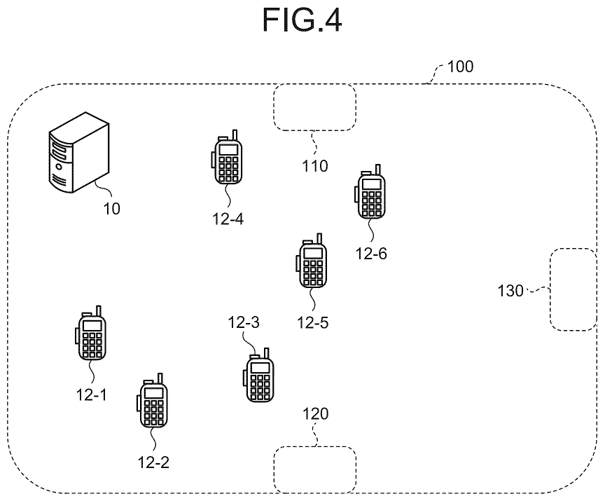

A group generation process according to the first embodiment will be described below with reference to FIG. 4. FIG. 4 is a diagram for explaining the group generation process according to the first embodiment.

As illustrated in FIG. 4, the guide system 1 is installed in a stadium 100 in which a concert or the like is held. In the example illustrated in FIG. 4, the guide system 1 includes the management apparatus 10 and the six communication terminal apparatuses 12, that is, the communication terminal apparatus 12-1 to a communication terminal apparatus 12-6. In the stadium 100, for example, three exits, that is, a north exit 110, a south exit 120, and a main exit 130, are provided. In the north exit 110, the south exit 120, and the main exit 130, to allow the communication terminal apparatus 12 that is carried by a person who is in charge of performing operation of evacuation guidance at each of the exits to generate a group and perform communication, a channel that is used by the first communication unit 50 of each of the communication terminal apparatus 12-1 to the communication terminal apparatus 12-6 is set in advance. The management apparatus 10 performs a process of allowing users (responsible persons) who carry the communication terminal apparatus 12-1 to the communication terminal apparatus 12-6 to generate groups or change the groups in accordance with exits that are used to let crowds to evacuate from the stadium 100.

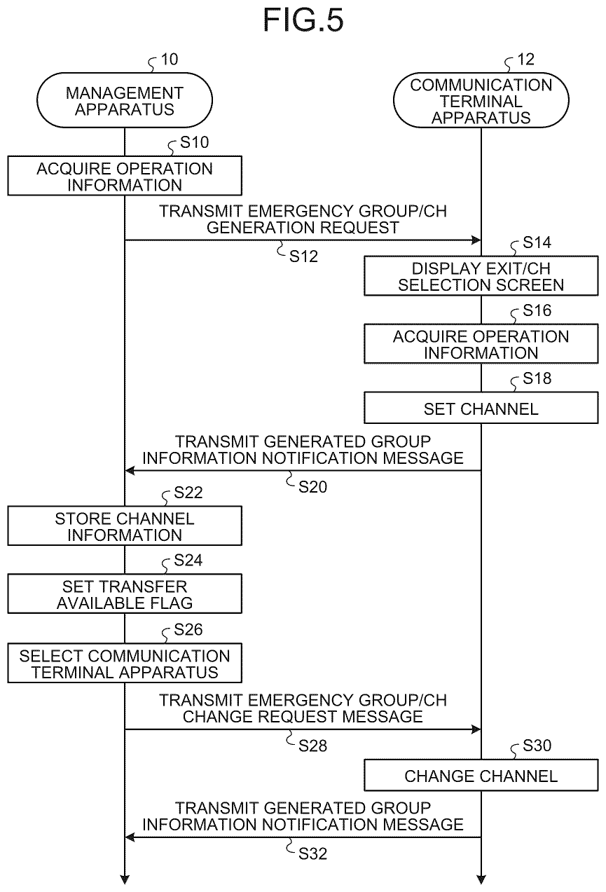

FIG. 5 is a sequence diagram illustrating the flow of the group generation process according to the first embodiment. The process illustrated in FIG. 5 indicates a process that is performed by the management apparatus 10 to generate groups of the communication terminal apparatuses 12 and change the groups when a disaster occurs.

The control unit 28 of the management apparatus 10 acquires operation information that indicates a request for generation of a group, where the request is input by an administrator to the operation unit 22 (Step S10). Then, the process goes to Step S12.

The control unit 28 of the management apparatus 10 transmits an “emergency group/CH generation request message” to all of the communication terminal apparatuses 12 that are included in the guide system 1 (Step S12). The “emergency group/CH generation request message” includes information for causing the user to generate a group. The “emergency group/CH generation request message” is an instruction signal for causing the user of the communication terminal apparatus 12 to select a channel to be used by the first communication unit 50. Then, the process goes to Step S14.

The display control unit 74 of the communication terminal apparatus 12 causes the display unit 56 to display an “exit/CH selection screen” when the communication terminal apparatus 12 receives the “emergency group/CH generation request message” (Step S14). The “exit/CH selection screen” is a selection screen that allows the user to select an exit (channel) at which the user performs the evacuation guidance in the stadium. In the present embodiment, for example, the channel that is used by the first communication unit 50 is set in advance in accordance with an exit. In the example illustrated in FIG. 4, for example, different channels are set such that a channel CH1 is set at the north exit 110, a channel CH2 is set at the south exit 120, and a channel CH3 is set at the main exit 130. Then, the process goes to Step S16.

The control unit 62 of the communication terminal apparatus 12 acquires operation information that is input by the user to the operation unit 54 and that indicates a selection of the exit at which a guidance for evacuation from the stadium is performed (Step S16). Then, the process goes to Step S18.

The setting unit 76 of the communication terminal apparatus 12 sets the channel that is used by the first communication unit 50 by the first communication system to the channel that is selected by the user in accordance with the exit (Step S18). In the example illustrated in FIG. 4, for example, when the user selects the north exit 110, the setting unit 76 sets the channel that is used by the first communication unit 50 by the first communication system to the channel CH1. Then, the process goes to Step S20.

The setting unit 76 of the communication terminal apparatus 12 generates a “generated group information notification message” and transmits the message to the management apparatus 10 via the first communication unit 50 (Step S20). The “generated group information notification message” includes information on a channel that is used by the communication terminal apparatus 12 by the first communication system and identification information, such as an ID, for identifying the communication terminal apparatus 12. The “generated group information notification message” is a kind of terminal information. Then, the process goes to Step S22.

The control unit 28 of the management apparatus 10 stores the “generated group information notification message” in the storage unit 26 when the management apparatus 10 receives the “generated group information notification message” (Step S22). Then, the process goes to Step S24.

The counting unit 40 of the management apparatus 10 counts the number of the communication terminal apparatuses 12 and sets a transfer available flag (Step S24). Specifically, the storage unit 60 of the management apparatus 10 stores therein, in advance, information on an upper limit value of the number of the communication terminal apparatuses 12 that can be arranged at each of the exits (channels) that are associated with location information, where the upper limit value is set by the upper limit value setting unit 42 in advance. The counting unit 40 counts the number of the communication terminal apparatuses 12 at each of the exits (channels) in order of reception of the “generated group information notification message” from each of the communication terminal apparatuses 12, and sets the transfer available flag for each of the communication terminal apparatuses 12 in order from the smallest to the largest IDs (in ascending order), with respect to the exceeding number of the communication terminal apparatuses 12 from the upper limit value. In other words, the counting unit 40 sets the transfer available flag for the communication terminal apparatuses 12 that use the channels that exceed the upper limit value. Then, the process goes to Step S26.

When a channel that falls below the upper limit value that is set by the upper limit value setting unit 42 is present, the terminal selection unit 44 of the management apparatus 10 selects the communication terminal apparatus 12 for which the exit is to be changed (Step S26). Specifically, the terminal selection unit 44 selects, in order from the smallest to the largest IDs, the communication terminal apparatus 12 for which the exit is to be changed, from among the communication terminal apparatuses 12 which use channels at the exits located close to the exit that falls below the upper limit value and for which the transfer available flags are set. Then, the process goes to Step S28.

The control unit 28 of the management apparatus 10 transmits an “emergence group/CH change request message” to the selected communication terminal apparatus 12 (Step S28). The “emergence group/CH change request message” includes information for causing the user to change the group. The “emergence group/CH change request message” includes channel information on a change destination. Then, the process goes to Step S30.

The change unit 80 of the communication terminal apparatus 12, when the communication terminal apparatus 12 receives the “emergence group/CH change request message”, changes the channel that is used by the first communication unit 50 (Step S30). Specifically, the change unit 80 changes the channel that is currently used by the first communication unit 50 to the channel that is indicated by the “emergence group/CH change request message”. The change unit 80, when the communication terminal apparatus 12 receives the “emergence group/CH change request message”, automatically changes the channel that is used by the first communication unit 50. In the example illustrated in FIG. 4, for example, when the user uses the channel CH1 by the first communication unit 50, the channel is automatically changed to the channel CH2 or the channel CH3. Specifically, in the present embodiment, when it is needed to change the group, it is possible to dynamically change members in the group. Then, the process goes to Step S32.

The change unit 80 of the communication terminal apparatus 12 generates the “generated group information notification message” and transmits the message to the management apparatus 10 via the first communication unit 50 (Step S32). Then, the process in FIG. 4 is terminated.

As described above, in the first embodiment, it is possible to generate groups of the communication terminal apparatuses 12 when a disaster occurs, and dynamically change the groups when the groups need to be changed. With this configuration, in the first embodiment, it is possible to appropriately place users (responsible persons) and guide crowds to evacuate.

### Second Embodiment

A second embodiment of the present disclosure will be described below. In the second embodiment, groups are dynamically changed based on a process that is performed by the second communication units 52 of the communication terminal apparatuses 12 based on near-field wireless communication between the communication terminal apparatuses 12.

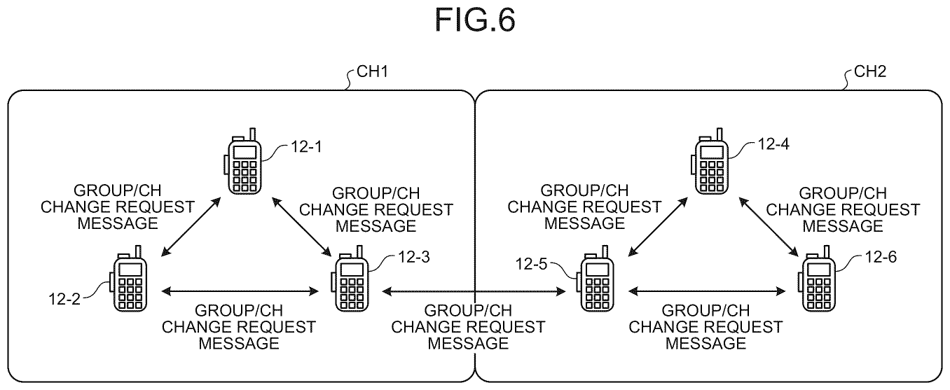

FIG. 6 is a diagram for explaining an overview of a process performed by the communication terminal apparatuses 12 according to the second embodiment. As illustrated in FIG. 6, it is assumed that the communication terminal apparatus 12-1, a communication terminal apparatus 12-2, and a communication terminal apparatus 12-3 belong to a group of the channel CH1. It is assumed that a communication terminal apparatus 12-4, a communication terminal apparatus 12-5, and the communication terminal apparatus 12-6 belong to a group of the channel CH2.

Each of the communication terminal apparatus 12-1 to the communication terminal apparatus 12-6 broadcasts the “group/CH change request message” at predetermined intervals by Bluetooth Low Energy (BLF) communication using Bluetooth by the second communication unit 52, for example. The “group/CH change request message” is information that indicates a request for change of the channel. The “group/CH change message” includes “group/CH information” on the channel that is currently used by the first communication unit 50. Specifically, the “group/CH information” that is received from the different communication terminal apparatus 12 is a kind of the first channel information. As illustrated in FIG. 6, the communication terminal apparatus 12-3 receives the “group/CH change request message” from the communication terminal apparatus 12-1 and the communication terminal apparatus 12-2 that belong to the channel CH1 and from the communication terminal apparatus 12-5 that belongs to the channel CH2. In this case, the communication terminal apparatus 12-3 that has received the “group/CH change request message” from the different group from the currently belonging group performs a group change process based on the “group/CH change request message”. A process will be described below by taking the communication terminal apparatus 12-3 as an example.

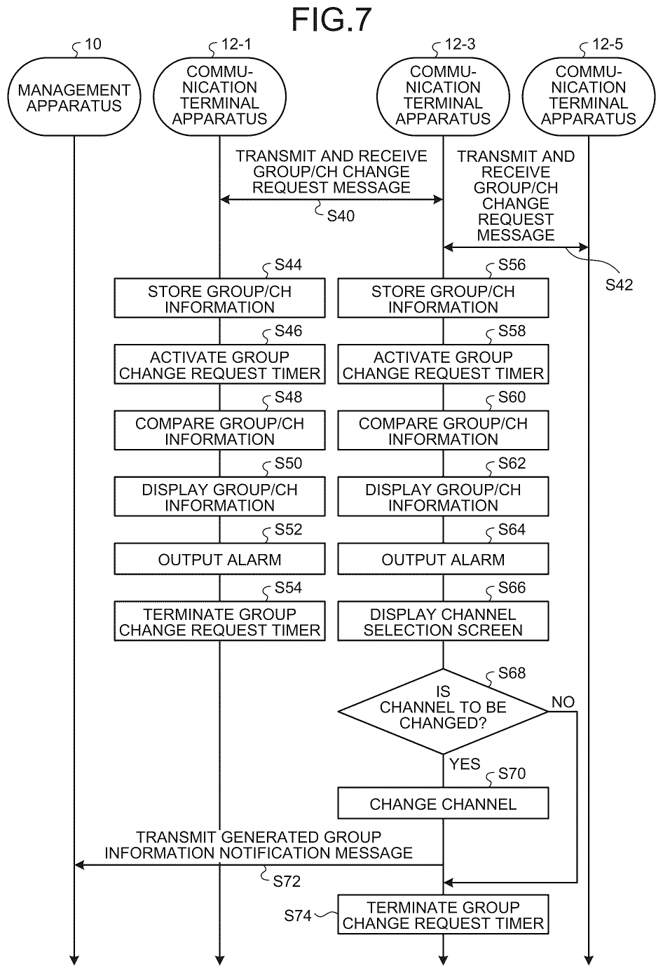

FIG. 7 is a sequence diagram illustrating the flow of a group generation process according to the second embodiment. The process illustrated in FIG. 7 is a process that is performed between the communication terminal apparatus 12-1 and the communication terminal apparatus 12-3 that belong to the channel CH1 and the communication terminal apparatus 12-5 that belongs to the channel CH2.

The second communication control unit 72 of each of the communication terminal apparatus 12-1 and the communication terminal apparatus 12-3 causes the second communication unit 52 to transmit the “group/CH change request message”, and the communication terminal apparatus 12-3 and the communication terminal apparatus 12-1 mutually receive the messages (Step S40). Then, the process goes to Step S42.

The second communication control unit 72 of each of the communication terminal apparatus 12-3 and the communication terminal apparatus 12-5 causes the second communication unit 52 to transmit the “group/CH change request message”, and the communication terminal apparatus 12-5 and the communication terminal apparatus 12-3 mutually receive the messages (Step S42). Then, the process goes to Step S44.

The second communication control unit 72 of the communication terminal apparatus 12-1 stores, in the storage unit 60, the “group/CH information” that is indicated by the “group/CH change request message” that is received from the communication terminal apparatus 12-3 (Step S44). When the capacity of the storage unit 60 is full, the second communication control unit 72 may overwrite the oldest “group/CH information” with the new “group/CH information”, for example. Then, the process goes to Step S46.

The control unit 62 of the communication terminal apparatus 12-1 activates a group change request timer (Step S46). The group change request timer is a timer that measures a time for receiving operation of changing the group from the user. Then, the process goes to Step S48.

The comparison unit 78 of the communication terminal apparatus 12-1 compares the channel that is indicated by the “group/CH information” on the communication terminal apparatus 12-3 stored in the storage unit 60 and the channel that is set in the subject first communication unit 50 (Step S48). At Step S48, the comparison unit 78 determines that the channel that is indicated by the “group/CH information” on the communication terminal apparatus 12-3 stored in the storage unit 60 and the channel that is set in the subject first communication unit 50 are the same. Then, the process goes to Step S50.

The display control unit 74 of the communication terminal apparatus 12-1 displays the “group/CH information” (Step S50). Specifically, the display control unit 74 displays information indicating that the channel that is used by the first communication unit 50 is the channel CH1. Then, the process goes to Step S52.

The control unit 62 of the communication terminal apparatus 12-1 causes the voice output unit 58 to output an alarm (Step S52). Specifically, the control unit 62 notifies the user of the communication terminal apparatus 12-1 that the group/CH change request message is received from the different communication terminal apparatus 12. The control unit 62 may cause a Light Emitting Diode (LED) (not illustrated) to emit light. Then, the process goes to Step S54.

The control unit 62 of the communication terminal apparatus 12-1 terminates the group change request timer due to a lapse of a predetermined time that is set in the group change request timer (Step S54). At this time, the communication terminal apparatus 12-1 does not perform a channel change process because the communication terminal apparatus 12-1 has not received the “group/CH change request message” from the communication terminal apparatus 12 that uses a different channel from the channel that the communication terminal apparatus 12-1 is using.

The second communication control unit 72 of the communication terminal apparatus 12-3 stores, in the storage unit 60, the “group/CH information” on the communication terminal apparatus 12-1 and the “group/CH information” on the communication terminal apparatus 12-5 (Step S56). Then, the process goes to Step S58.

The control unit 62 of the communication terminal apparatus 12-3 activates the group change request timer (Step S58). Then, the process goes to Step S60.

The comparison unit 78 of the communication terminal apparatus 12-3 compares the channels that are indicated by the “group/CH information” on the communication terminal apparatus 12-1 and on the communication terminal apparatus 12-5 stored in the storage unit 60 and the channel that is set in the subject first communication unit 50 (Step S60). At Step S60, the comparison unit 78 determines that the channel that is indicated by the “group/CH information” on the communication terminal apparatus 12-1 and the channel that is set in the subject first communication unit 50 are the same. The comparison unit 78 determines that the channel that is indicated by the “group/CH information” on the communication terminal apparatus 12-5 and the channel that is set in the subject first communication unit 50 are different. Then, the process goes to Step S62.

The display control unit 74 of the communication terminal apparatus 12-3 displays the “group/CH information” (Step S62). Specifically, the display control unit 74 displays information indicating that the channel that is used by the first communication unit 50 is the channel CH1 and information indicating that the channel that is used by the communication terminal apparatus 12-5 is the channel CH2. Then, the process goes to Step S64.

The control unit 62 of the communication terminal apparatus 12-3 causes the voice output unit 58 to output an alarm (Step S64). Then, the process goes to Step S66.

The display control unit 74 of the communication terminal apparatus 12-3 causes the display unit 56 to display a channel selection screen (Step S66). Specifically, the display control unit 74 displays a screen in which, for example, “Yes” is to be selected when the channel is changed from the channel CH1 to the channel CH2, and “No” is to be selected when the channel is not changed. Then, the process goes to Step S68.

The change unit 80 of the communication terminal apparatus 12-3 determines whether or not to change the channel (Step S68). Specifically, when acquiring operation information for changing the channel from the operation unit 54, the change unit 80 determines that the channel is to be changed. For example, when the operation unit 54 selects “Yes” that is displayed on the channel selection screen, the change unit 80 determines that the channel is to be changed. Operation for the change may be interlocked with operation on the PTT button or the like that is included in the operation unit 54, for example. When it is determined that the channel is to be changed (Step S68; Yes), the process goes to Step S70. When it is not determined that the channel is to be changed (Step S68; No), the process goes to Step S74.

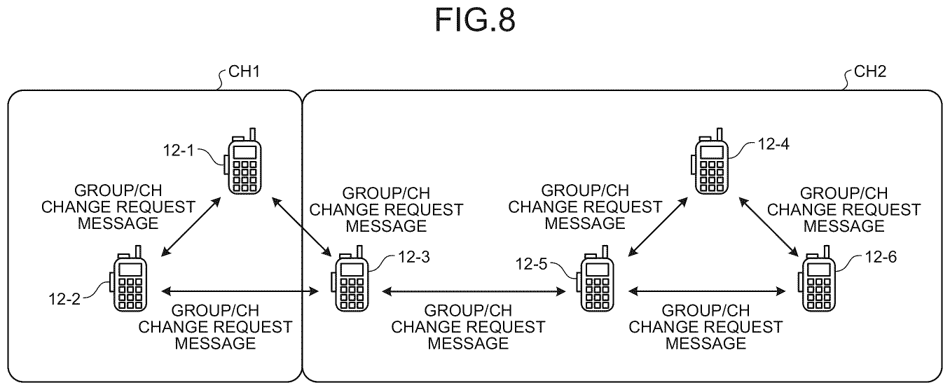

When it is determined as Yes at Step S68, the change unit 80 of the communication terminal apparatus 12-3 changes the channel (Step S70). FIG. 8 is a diagram for explaining a change of a channel according to the second embodiment. As illustrated in FIG. 8, the change unit 80 changes the channel that is used by the communication terminal apparatus 12-1 in the first communication unit 50 from the channel CH1 to the channel CH2. With this configuration, the communication terminal apparatus 12-1 and the communication terminal apparatus 12-2 belong to the group of the channel CH1. The communication terminal apparatus 12-3, the communication terminal apparatus 12-4, the communication terminal apparatus 12-5, and the communication terminal apparatus 12-6 belong to the group of the channel CH2. Then, the process goes to Step S72.

The change unit 80 of the communication terminal apparatus 12-3 generates a “generated group information notification message” and transmits the message to the management apparatus 10 via the first communication unit 50 (Step S72). Then, the process goes to Step S74.

When it is determined as No at Step S68 or after Step S72, the control unit 62 of the communication terminal apparatus 12-3 terminates the group change request timer due to a lapse of a predetermined time that is set in the group change request timer (Step S74). Then, the process illustrated in FIG. 7 is terminated.

As described above, in the second embodiment, it is possible to dynamically change the group by a process based on the near-field wireless communication between the communication terminal apparatuses. In the second embodiment, for example, even the communication terminal apparatus that is not able to calculate a current location based on a Global Navigation Satellite System (GNSS) signal is able to change the channel by mutual communication with the communication terminal apparatuses. With this configuration, in the second embodiment, it is possible to appropriately generate a group and allow each of users to guide crowds to evacuate. Furthermore, in the second embodiment, it is possible to change the channel by certain communication, such as BLE, so that it is possible to change the channel of each of the communication terminal apparatuses without occupying communication radio.

### Modification of Second Embodiment

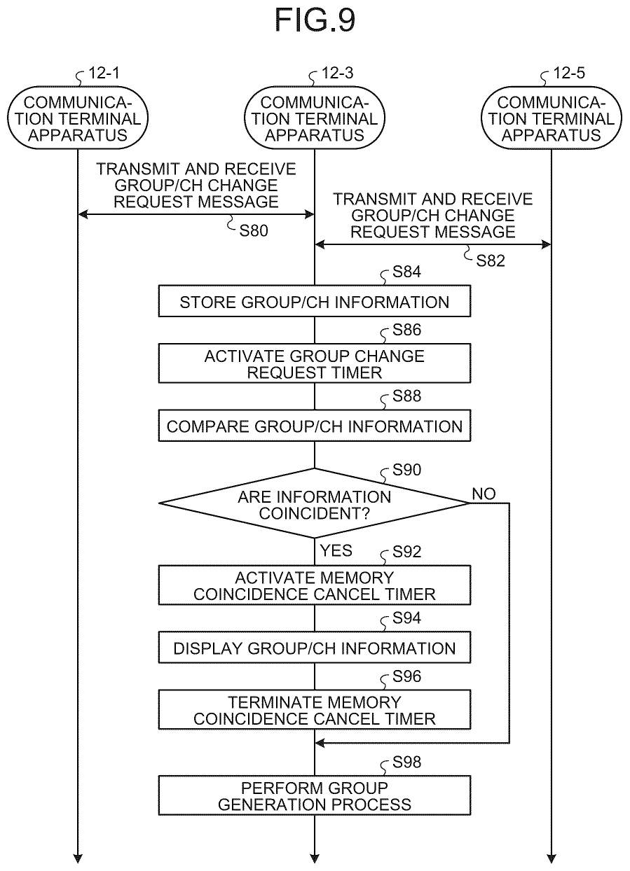

A process performed by a communication terminal apparatus according to a modification of the second embodiment will be described below with reference to FIG. 9. FIG. 9 is a sequence diagram illustrating the flow of a process performed by the communication terminal apparatus according to the modification of the second embodiment.

The process illustrated in FIG. 9 is a process that is performed when, after changing the channel from the channel CH1 to the channel CH2 (see FIG. 8), the communication terminal apparatus 12-3 receives the group/CH change request message from the communication terminal apparatus 12-1 and the communication terminal apparatus 12-5 again.

Processes from Step S80 to Step S88 are the same as the processes at Step S40, Step S42, and Step S56 to Step S60 illustrated in FIG. 7, and therefore, explanation thereof will be omitted.

The comparison unit 78 of the communication terminal apparatus 12-3 determines whether or not the “group/CH information” that is received at Step S80 and Step S82 coincides with the “group/CH information” that is stored in the storage unit 60 (Step S90). When it is determined that the information coincide with each other (Step S90; Yes), the process goes to Step S92. When it is not determined that the information coincide with each other (Step S90; No), the process goes to Step S98.

When it is determined as Yes at Step S90, the control unit 62 of the communication terminal apparatus 12-3 activates a memory coincidence cancel timer (Step S92). The memory coincidence cancel timer is a timer for preventing output of an alarm. Then, the process goes to Step S94.

The display control unit 74 of the communication terminal apparatus 12-3 displays the “group/CH information” (Step S94). Specifically, the display control unit 74 displays information indicating that the channel that is used by the first communication unit 50 is the channel CH2 and information indicating that the channel that is used by the communication terminal apparatus 12-1 is the channel CH1. Then, the process goes to Step S96.

The control unit 62 of the communication terminal apparatus 12-3 terminates the memory coincidence cancel timer due to a lapse of a predetermined time that is set in the memory coincidence cancel timer (Step S96). Then, the process goes to Step S98.

When it is determined as No at Step S90 or after Step S96, the control unit 62 of the communication terminal apparatus 12-3 performs the group generation process (Step S98). Specifically, the control unit 62 performs the process as illustrated in FIG. 7. Then, the process illustrated in FIG. 9 is terminated.

### Third Embodiment

A third embodiment of the present disclosure will be described below. In the third embodiment, groups are dynamically changed based on an instruction that is given by the management apparatus 10.

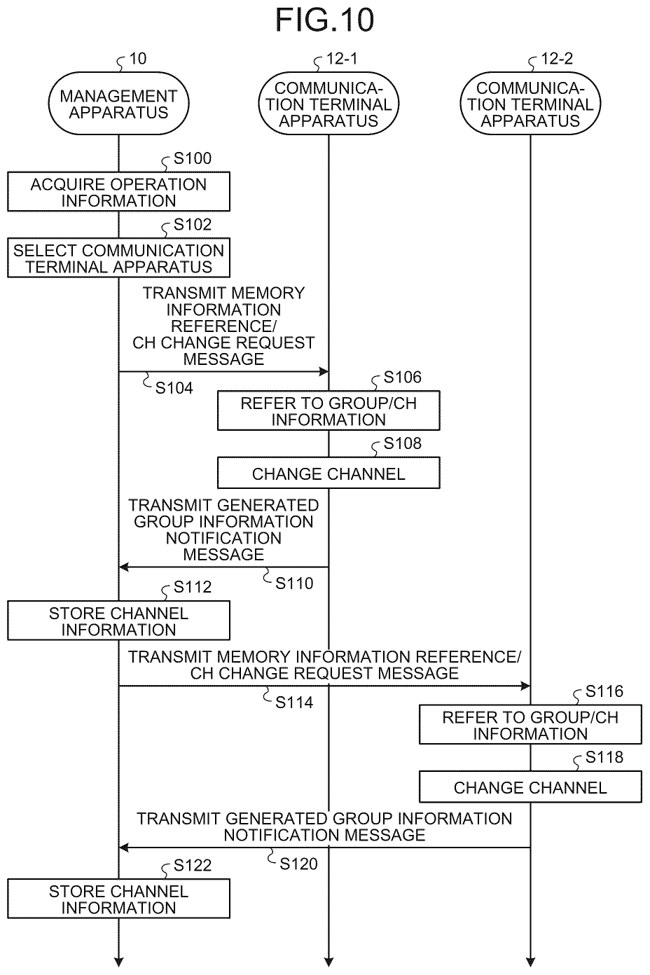

FIG. 10 is a sequence diagram illustrating the flow of a group generation process according to the third embodiment. The process illustrated in FIG. 10 is a process for dynamically changing members of groups based on determination that is made by the management apparatus 10.

The control unit 28 of the management apparatus 10 acquires operation information that indicates a request for change of a group, where the request is input by an administrator to the operation unit 22 (Step S100). The operation information includes, in the example illustrated in FIG. 4 for example, operation of changing the upper limit value of the number of the communication terminal apparatuses 12 that are used by responsible persons at each of the exits, that is, the number of the responsible persons. Then, the process goes to Step S102.

The terminal selection unit 44 of the management apparatus 10 selects the communication terminal apparatus 12 for which the channel is to be changed (Step S102). Specifically, the terminal selection unit 44 selects the communication terminal apparatus 12 for which the transfer available flag is set. More specifically, the terminal selection unit 44 selects the communication terminal apparatuses 12 for which the transfer available flags are set, in order from the smallest to the largest IDs, in accordance with the number of the communication terminal apparatuses 12 for which the channels are to be changed. In the example illustrated in FIG. 10, it is assumed that the two communication terminal apparatuses, that is, the communication terminal apparatus 12-1 and the communication terminal apparatus 12-2, are selected. Then, the process goes to Step S104.

The control unit 28 of the management apparatus 10 transmits a “memory information reference/CH change request message” to the selected communication terminal apparatus 12-1 (Step S104). The “memory information reference/CH change request message” includes channel information on a change destination channel. Then, the process goes to Step S106.

The change unit 80 of the communication terminal apparatus 12-1 refers to the “group/CH information” that is stored in the storage unit 60 (Step S106). Then, the process goes to Step S108.

The change unit 80 of the communication terminal apparatus 12-1 changes the channel that is used by the first communication unit 50 (Step S108). Specifically, when the change destination channel that is included in the “memory information reference/CH change request message” and the newest channel that is stored in the storage unit 60 are the same, the change unit 80 changes the channel that is used by the first communication unit 50 to the change destination channel that is included in the “memory information reference/CH change request message”. Then, the process goes to Step S110.

The change unit 80 of the communication terminal apparatus 12-1 generates the “generated group information notification message” and transmits the message to the management apparatus 10 via the first communication unit 50 (Step S110). Then, the process goes to Step S112.

The control unit 28 of the management apparatus 10 stores, in the storage unit 26, the channel information (first channel information) that is indicated by the “generated group information notification message” that is received from the communication terminal apparatus 12-1 (Step S112). Then, the process goes to Step S114.

The control unit 28 of the management apparatus 10 transmits the “memory information reference/CH change request message” to the selected communication terminal apparatus 12-2 (Step S114). Then, the process goes to Step S116.

The storage unit 60 of the communication terminal apparatus 12-2 stores channel information on the change destination channel that is included in the “memory information reference/CH change request message” as the newest information. The change unit 80 of the communication terminal apparatus 12-2 refers to the group/CH information that is stored in the storage unit 60 (Step S116). Then, the process goes to Step S118.

The change unit 80 of the communication terminal apparatus 12-2 changes the channel that is used by the first communication unit 50 (Step S118). Then, the process goes to Step S120.

The change unit 80 of the communication terminal apparatus 12-2 generates the “generated group information notification message” and transmits the message to the management apparatus 10 via the first communication unit 50 (Step S120). Then, the process goes to Step S122.

The control unit 28 of the management apparatus 10 stores, in the storage unit 26, the channel information (first channel information) that is indicated by the “generated group information notification message” that is received from the communication terminal apparatus 12-2 (Step S122).

As described above, in the third embodiment, when causing crowds to evacuate from the stadium, it is possible to dynamically change the upper limit value of the number of users (number of responsible persons) at each of the exits, and dynamically change the channel that is used by each of the users in accordance with the changed upper limit value.

The components of the apparatuses illustrated in the drawings are functionally conceptual and do not necessarily have to be physically configured in the manner illustrated in the drawings. Specifically, specific forms of distribution and integration of the apparatuses are not limited to those illustrated in the drawings, and all or part of the apparatuses may be functionally or physically distributed or integrated in arbitrary units depending on various loads or use conditions. Meanwhile, the configuration based on distribution or integration may be performed dynamically.

According to the present disclosure, it is possible to dynamically change members in a group.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication terminal apparatus comprising:
a first communication unit that performs communication by a first communication system;
a second communication unit that performs communication by a second communication system as a near-field communication system that is different from the first communication system;
a storage unit that stores therein pieces of channel information on channels that perform communication by respective systems;
a comparison unit that compares the pieces of channel information that are stored in the storage unit;
a display unit that displays the pieces of channel information; and
an operation unit that is able to select a piece of channel information displayed on the display unit, wherein
the second communication unit receives first channel information on a first channel that is used by a closely-located different communication terminal apparatus by the first communication system,
the storage unit stores therein the first channel information that is received by the second communication unit,
the comparison unit compares whether or not the first channel information that is stored and second channel information on a channel that is used by the subject communication terminal apparatus by the first communication unit coincide with each other,
the display unit displays the first channel information when a comparison result obtained by the comparison unit does not indicate coincidence, and
the first communication unit performs change to the first channel and performs communication when the first channel that is displayed on the display unit is selected.

2. The communication terminal apparatus according to claim 1, wherein when a channel that is used by the first communication system is changed, the first communication unit transmits, as terminal information, information on the changed channel and an identifier of the subject apparatus to a management apparatus.

3. A management apparatus comprising:
a communication unit that performs communication with a communication terminal apparatus by a first communication system;
a storage unit that stores therein terminal information that is received by the communication unit, the terminal information being information in which information on a channel that is used by the communication terminal apparatus by the first communication system and an identifier of the communication terminal apparatus are associated with each other;
a counting unit that counts, for each of channels, number of the communication terminal apparatuses that use a same channel, based on the terminal information that is stored in the storage unit;
an upper limit value setting unit that sets, for each of the channels, an upper limit value of number of used apparatuses; and
a terminal selection unit that selects the communication terminal apparatus that is to be requested to change a used channel to a different channel, based on the number of the used apparatuses that is counted by the counting unit for each of the channels and based on the upper limit value that is set by the upper limit value setting unit for each of the channels, wherein
the terminal selection unit transmits information on a channel to be changed to the selected communication terminal apparatus by the communication unit, wherein
the communication unit transmits an instruction signal for selecting a channel to be used to the communication terminal apparatus, and receives selected terminal information from the communication terminal apparatus,
the storage unit stores therein information in which location information is associated with each of the channels, and
the terminal selection unit transmits, to the communication terminal apparatus that is using a channel for which the number of used apparatuses exceeds the upper limit value, channel information to allow a change to a channel which is associated with location information that is close in distance to location information on the used channel and which has not reached the upper limit value, by the communication unit.

4. A management apparatus comprising:
a communication unit that performs communication with a communication terminal apparatus by a first communication system;
a storage unit that stores therein terminal information that is received by the communication unit, the terminal information being information in which information on a channel that is used by the communication terminal apparatus by the first communication system and an identifier of the communication terminal apparatus are associated with each other;
a counting unit that counts, for each of channels, number of the communication terminal apparatuses that use a same channel, based on the terminal information that is stored in the storage unit;
an upper limit value setting unit that sets, for each of the channels, an upper limit value of number of used apparatuses; and
a terminal selection unit that selects the communication terminal apparatus that is to be requested to change a used channel to a different channel, based on the number of the used apparatuses that is counted by the counting unit for each of the channels and based on the upper limit value that is set by the upper limit value setting unit for each of the channels, wherein
the terminal selection unit transmits information on a channel to be changed to the selected communication terminal apparatus by the communication unit, wherein
when the upper limit value that is set by the upper limit value setting unit for each of the channels is changed, the terminal selection unit transmits, to the communication terminal apparatus that is using a channel for which the number of used apparatuses exceeds the upper limit value, channel information to allow a change to a channel for which the upper limit value is increased and which has not reached the upper limit value, by the communication unit.
